(19) United States
(12) Patent Application Publication
(10) Pub. No.: US 2025/0090960 A1
(43) Pub. Date: Mar. 20, 2025

(54) INFORMATION PROCESSING PROGRAM, INFORMATION PROCESSING METHOD, INFORMATION PROCESSING APPARATUS, AND INFORMATION PROCESSING SYSTEM

(71) Applicant: KOEI TECMO GAMES CO., LTD., Yokohama-shi (JP)

(72) Inventors: Masakazu HIRAYAMA, Kanagawa (JP); Masaki YOKOTA, Kanagawa (JP)

(21) Appl. No.: 18/608,974

(22) Filed: Mar. 19, 2024

(30) Foreign Application Priority Data
Sep. 15, 2023 (JP) 2023-150583

(51) Int. Cl. A63F 13/69; A63F 13/56

(52) U.S. Cl. CPC A63F 13/69; A63F 13/56

(57) ABSTRACT

An information processing program causes a computer to execute: acquiring loss information regarding a loss of a first character controlled by a first player to an enemy character, and granting a benefit to the first player based on the loss information in a case in which a second character controlled by a second player, different from the first player, wins against the enemy character to which the first character has lost.

### CROSS-REFERENCE TO RELATED APPLICATION

This application is based on and claims priority under 35 USC 119 from Japanese Patent Application No. 2023-150583, filed on Sep. 15, 2023, the disclosure of which is incorporated by reference herein.

### BACKGROUND

### Technical Field

The present disclosure relates to an information processing program, an information processing method, an information processing apparatus, and an information processing system.

### Related Art

Conventionally, games in which a player character controlled by a player acquires an experience value by winning against an enemy character, and the player character is leveled up according to the acquired experience value have been known.

For example, Japanese Patent Application Laid-Open (JP-A) No. 2007-195676 discloses a technology in which an experience value, which has been acquired from a nearest save point to the time when a video game is over, is reflected at the time of “continue” in accordance with a desire of a player.

By the way, there is known a game in which, when a character controlled by a first player loses to an enemy character, a second player is notified of the loss of the character controlled by the first player. However, in such a game, the first player is not allowed to obtain an advantage of making a notification about the loss.

### SUMMARY

An object of the disclosure is to provide an information processing program, an information processing method, an information processing apparatus, and an information processing system which enable a player to obtain an advantage of making a notification about a loss.

An information processing program according to a first aspect causes a computer to execute acquiring loss information regarding a loss of a first character controlled by a first player to an enemy character; and granting a benefit to the first player based on the loss information in a case in which a second character controlled by a second player, different from the first player, wins against the enemy character to which the first character has lost.

An information processing program according to a second aspect is the information processing program according to the first aspect, in which the loss information is information regarding the loss of the first character to the enemy character in a first virtual space in which the first character is arranged, the information processing program causing the computer to execute granting a benefit to the first player in the first virtual space based on the loss information in a case in which the second character wins against an enemy character corresponding to the enemy character to which the first character has lost in the first virtual space in a second virtual space in which the second character is arranged, the second virtual space being different from the first virtual space.

An information processing program according to a third aspect is the information processing program according to the first aspect, and causes the computer to execute enhancing the enemy character to which the first character has lost based on the loss information.

An information processing program according to a fourth aspect is the information processing program according to the third aspect, and causes the computer to execute increasing, in a case in which a plurality of the first characters controlled by a plurality of the first players have lost to one identical enemy character, a degree of enhancement of the one enemy character as a number of the first characters having lost to the one enemy character increases.

An information processing program according to a fifth aspect is the information processing program according to the fourth aspect, and causes the computer to execute setting an upper limit value of the degree of enhancement designated by the second player.

An information processing program according to a sixth aspect is the information processing program according to any one of the first to fifth aspects, and causes the computer to execute granting a benefit to the second player based on the loss information in a case in which the second character wins against the enemy character to which the first character has lost.

An information processing program according to a seventh aspect is the information processing program according to the sixth aspect, and causes the computer to execute granting a better benefit to the second player as a number of the first characters having lost to the enemy character increases in a case in which the second character wins against the enemy character to which a plurality of the first characters controlled by a plurality of the first players has lost.

An information processing program according to an eighth aspect is the information processing program according to any one of the first to seventh aspects, and causes the computer to execute: displaying a mark at a position where the first character has lost to the enemy character based on the loss information; and enhancing the second character in a case in which the second character performs a predetermined action with respect to the mark.

An information processing program according to a ninth aspect is the information processing program according to any one of the first to eighth aspects, and causes the computer to execute acquiring the loss information at each specific timing.

An information processing method according to a tenth aspect includes: acquiring, by a computer, loss information regarding a loss of a first character controlled by a first player to an enemy character; and granting, by the computer, a benefit to the first player based on the loss information in a case in which a second character controlled by a second player, different from the first player, wins against the enemy character to which the first character has lost.

An information processing apparatus according to an eleventh aspect includes a processor, the processor being configured to: acquire loss information regarding a loss of a first character controlled by a first player to an enemy character; and grant a benefit to the first player based on the loss information in a case in which a second character controlled by a second player, different from the first player, wins against the enemy character to which the first character has lost.

An information processing system according to a twelfth aspect includes: a first information processing apparatus including a processor and configured to provide a first virtual space in which a first character controlled by a first player is arranged; and a second information processing apparatus including a processor and configured to provide a second virtual space in which a second character controlled by a second player, different from the first player, is arranged, the second virtual space being different from the first virtual space, in which the processor of the second information processing apparatus is configured to acquire loss information regarding a loss of the first character to an enemy character in the first virtual space, and make a notification about a win of the second character against the enemy character to which the first character has lost based on the loss information in a case in which the second character wins, in the second virtual space, against an enemy character corresponding to the enemy character to which the first character has lost in the first virtual space, and the processor of the first information processing apparatus is configured to grant a benefit to the first player in the first virtual space in a case in which the notification about the win of the second character against the enemy character to which the first character has lost is made.

According to the disclosure, it is possible to enable the player to obtain the advantage of making the notification about the loss.

### BRIEF DESCRIPTION OF THE DRAWINGS

Exemplary embodiments of the present disclosure will be described in detail based on the following figures, wherein:

FIG. 1 is a block diagram illustrating an example of a configuration of an information processing system;

FIG. 2 is a block diagram illustrating an example of a hardware configuration of an information processing apparatus 12;

FIG. 3 is a block diagram illustrating an example of a hardware configuration of an information processing apparatus 14;

FIG. 4 is a block diagram illustrating an example of a functional configuration of the information processing apparatus 12;

FIG. 5 is a diagram illustrating an example of a display screen in a state where a character approaches a mark;

FIG. 6 is a flowchart illustrating an example of a notification process;

FIG. 7 is a flowchart illustrating an example of a benefit granting process; and

FIG. 8 is a diagram for describing an effect obtained by acquiring loss information at each specific timing.

### DETAILED DESCRIPTION

Hereinafter, exemplary embodiments of the technology of the disclosure will be described in detail with reference to the drawings.

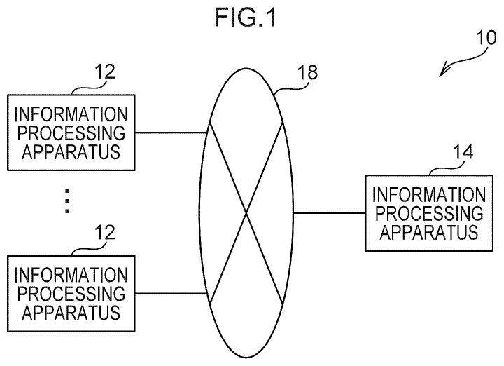

First, a configuration of an information processing system 10 will be described with reference to FIG. 1. The information processing system 10 includes a plurality of information processing apparatuses 12 and one information processing apparatus 14. Each of the information processing apparatuses 12 and the information processing apparatus 14 are connected to a network 18. Each of the information processing apparatuses 12 and the information processing apparatus 14 can transmit and receive data via the network 18. Although FIG. 1 illustrates an example in which the one information processing apparatus 14 is provided, two or more information processing apparatuses 14 may be provided in a distributed manner.

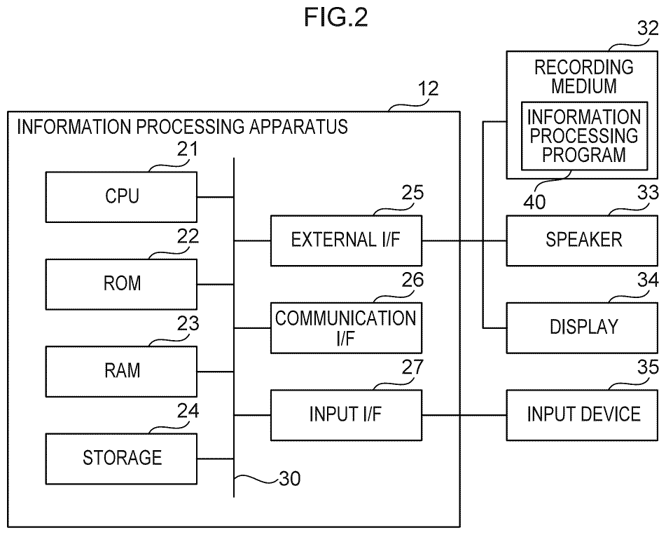

Next, a hardware configuration of the information processing apparatus 12 according to the embodiment will be described with reference to FIG. 2. Examples of the information processing apparatus 12 include a home game machine, a portable game machine, a business game machine, a smartphone, a tablet terminal, a personal computer, and the like. In the embodiment, an example in which the home game machine is applied as the information processing apparatus 12 will be described. The information processing apparatus 12 is an example of a computer.

As illustrated in FIG. 2, the information processing apparatus 12 includes a central processing unit (CPU) 21, a read only memory (ROM) 22, a random access memory (RAM) 23, a storage 24, an external interface (I/F) 25, a communication I/F 26, and an input I/F 27. The CPU 21, the ROM 22, the RAM 23, the storage 24, the external I/F 25, the communication I/F 26, and the input I/F 27 are connected to be capable of communicating with each other via a bus 30.

The CPU 21 is a central processing unit, and executes various programs and controls each unit. The CPU 21 is an example of a processor. The ROM 22 stores various programs and various types of data. The RAM 23 temporarily stores programs or data as a work area. The storage 24 includes a storage device such as a hard disk drive (HDD), a solid state drive (SSD), or a flash memory, and stores various programs and various types of data.

The external I/F 25 is an interface configured to connect various external devices to the information processing apparatus 12. In the embodiment, a recording medium 32, a speaker 33, and a display 34 are connected to the external I/F 25.

As the recording medium 32, an optical disk, a universal serial bus (USB) memory, an SD memory card, or the like is used. The recording medium 32 stores an information processing program 40 configured to execute a predetermined game in the information processing apparatus 12. The CPU 21 reads the information processing program 40 from the recording medium 32 via the external I/F 25, and executes the information processing program 40 using the RAM 23 as the work area. Note that the information processing program 40 is not limited to an aspect of being stored in the recording medium 32, and may be stored in advance in the storage 24 or may be downloadable to the information processing apparatus 12 via the communication I/F 26.

The speaker 33 outputs various sounds. The speaker 33 may be integrated with the information processing apparatus 12 or may be integrated with the display 34. The display 34 is, for example, a liquid crystal display or an organic electro luminescence (EL) display, and displays various types of information. The display 34 may be integrated with a touch panel. In addition, the display 34 may be integrated with the information processing apparatus 12.

The communication I/F 26 is an interface configured to connect the information processing apparatus 12 to the network 18. For the communication I/F 26, for example, a wired communication standard such as Ethernet (registered trademark) or a fiber distributed data interface (FDDI), or a wireless communication standard such as 4G, 5G, or Wi-Fi (registered trademark) is used.

The input I/F 27 is an interface configured to connect an input device 35 to the information processing apparatus 12. The input device 35 includes a controller having operation buttons, direction keys, and the like, a mouse, a keyboard, and the like, and is used to perform various inputs. A user operates a game using the input device 35. Operation information indicating a content of an input operation performed by the user using the input device 35 is stored in the RAM 23. The input device 35 may be integrated with the information processing apparatus 12. In addition, the input device 35 may be detachably attached to the information processing apparatus 12. In addition, the number of the input devices 35 may be one or more. In addition, the input device 35 may be the touch panel integrated with the display 34.

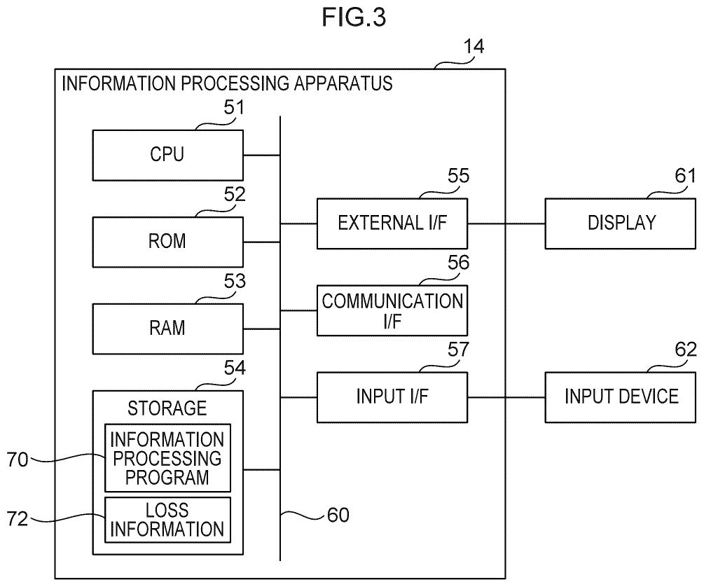

Next, a hardware configuration of the information processing apparatus 14 according to the embodiment will be described with reference to FIG. 3. The information processing apparatus 14 is, for example, a server computer, a cloud server, or the like.

As illustrated in FIG. 3, the information processing apparatus 14 includes a CPU 51, a ROM 52, a RAM 53, a storage 54, an external I/F 55, a communication I/F 56, and an input I/F 57. The CPU 51, the ROM 52, the RAM 53, the storage 54, the external I/F 55, the communication I/F 56, and the input I/F 57 are connected to be capable of communicating with each other via a bus 60.

The CPU 51 is a central processing unit, and executes various programs and controls each unit. The ROM 52 stores various programs and various types of data. The RAM 53 temporarily stores programs or data as a work area. The storage 54 includes a storage device such as an HDD, an SSD, or a flash memory, and stores various programs including an information processing program 70 and various types of data. The CPU 51 reads the information processing program 70 from the storage 54, and executes the information processing program 70 using the RAM 53 as the work area. Note that the information processing program 70 is not limited to an aspect of being stored in the storage 54, and may be stored in a recording medium such as a CD-ROM, a DVD-ROM, a USB memory, or an SD memory card and readable. In addition, the information processing program 70 may be downloadable to the information processing apparatus 14 via the communication I/F 56. In addition, loss information 72 is stored in the storage 54. Details of the loss information 72 will be described later.

The external I/F 55 is an interface configured to connect various external devices to the information processing apparatus 14. In the embodiment, a display 61 is connected to the external I/F 55.

The display 61 is, for example, a liquid crystal display or an organic EL display, and displays various types of information. The display 61 may be integrated with a touch panel. In addition, the display 61 may be integrated with the information processing apparatus 14.

The communication I/F 56 is an interface configured to connect the information processing apparatus 14 to the network 18. For the communication I/F 56, for example, a wired communication standard such as Ethernet (registered trademark) or FDDI, or a wireless communication standard such as 4G, 5G, or Wi-Fi (registered trademark) is used.

The input I/F 57 is an interface configured to connect an input device 62 to the information processing apparatus 14. The input device 62 includes a mouse, a keyboard, and the like, and is used to perform various inputs. The input device 62 may be the touch panel integrated with the display 61.

The information processing apparatus 12 according to the embodiment provides a game in which a character controlled in a virtual space on the game by a player who is a user of the information processing apparatus 12 battles with enemy characters. In this game, the enemy characters are arranged on a path along which the character travels. Although a case where the enemy characters are non-player characters (NPCs) will be described in the embodiment as an example, the disclosed technology is not limited to such an aspect. The enemy characters may be characters controlled by players or any combination of the characters and the NPCs. The game is a set of activities and rules for performing play and competition. The game is played, for example, by players using strategies and skills to achieve particular goals. The game is played to achieve various goals, for example, a goal in competition such as a win or a loss, a goal in a battle such as beating an enemy, an educational goal such as learning, and a narrative goal such as completing the progress of a scenario. The game may be a format of competing against each other or a format of not competing against each other.

In addition, the information processing apparatus 12 provides the game in which a level that determines power is set for a character. Specifically, a first level, which is maintained even in the case of exceeding a predetermined range, and a second level, which is not maintained in the case of exceeding the predetermined range, are set for the character. In the embodiment, a case where a range defined by a stage is applied as the predetermined range will be described as an example.

The game provided by the information processing apparatus 12 includes a plurality of stages, and a player clears the game by performing selection of a stage and clearing of the selected stage for all the stages. That is, a stage refers to a range that defines a plurality of units prepared in a game to be cleared by a player, and is also referred to as a mission, a quest, or the like depending on the game. Note that the above-described predetermined range may be a range defined by time, such as the first level being a level that is maintained for 9999 hours and the second level being a level that is maintained for 1 hour. In addition, the predetermined range may be a geographical range including a certain spot, a range as a distance from a certain spot to another spot, a range between a certain character or object and another character or object, or the like.

The first level is a level that is maintained even in a case in which the character shifts from a stage, and determines numerical values indicating the ability of the character. The first level is set to an initial value at the start of the game, and increases the numerical values indicating the ability of the character as the level increases. As a result, the first level enhances the character. Examples of the numerical values indicating the ability of the character include numerical values indicating the basic ability of the character such as strength, hit points, and agility. The first level is set to raise the character for a long term from the start of the game to clearing of the game.

The second level is a level that is not maintained in a case in which the character shifts from a stage, and is set for each stage. The second level determines a variation amount of the numerical values indicating the ability of the character. The variation amount refers to, for example, a weighting factor used when damage caused when the character attacks an enemy character, damage received when the character is attacked by the enemy character, and the like on the basis of the numerical values indicating the ability of the character. In this manner, the CPU 21 of the information processing apparatus 12 according to the embodiment adjusts the power of the character on the basis of the first level and the second level. The second level is set to an initial value at the start of each stage, and the level increases or decreases according to predetermined conditions. In addition, the second level is also set for the enemy character. Note that the first level may also be set for the enemy character. In addition, the second level may increase or decrease the numerical values indicating the ability of the character, or may correct the numerical values indicating the ability of the character determined by the first level. In addition, the second level may determine an element other than the numerical values indicating the ability of the character. Examples of the element in this case include a skill that can be used by the character, and the like.

In addition, the information processing apparatus 12 according to the embodiment provides a different virtual space for each player in the game. For example, in a case in which a plurality of players simultaneously play the same stage by operating the information processing apparatuses 12 respectively held by the players, the same enemy character is arranged at the same position in the stage, but a virtual space representing the stage is different for each of the players. Therefore, even if a character controlled by a certain player damages the enemy character, the enemy character is not damaged in a virtual space played by another player. That is, the second level of the enemy character and status such as remaining hit points of the enemy character are different depending on play situations in the virtual spaces played by the respective players.

In such a game, it is conceivable to notify a second player different from a first player of a loss of a character controlled by the first player in a case in which the character controlled by the first player has lost to an enemy character in order to allow each of the players to know the play situations of the other players. The information processing apparatus 12 according to the embodiment has a function for obtaining an advance that the first player makes a notification about the loss. The expression that “the player makes a notification about the loss” as used herein means that information regarding the loss is transmitted from an account associated with the player to the information processing apparatus 14 or the other players. In other words, the information processing apparatus 12 operated by the first player makes the notification about the loss.

Hereinafter, a case where a first information processing apparatus 12 provides a first virtual space in which a first character controlled by a first player is arranged, and a second information processing apparatus 12 provides a second virtual space which is different from the first virtual space and in which a second character controlled by a second player is arranged will be described as an example.

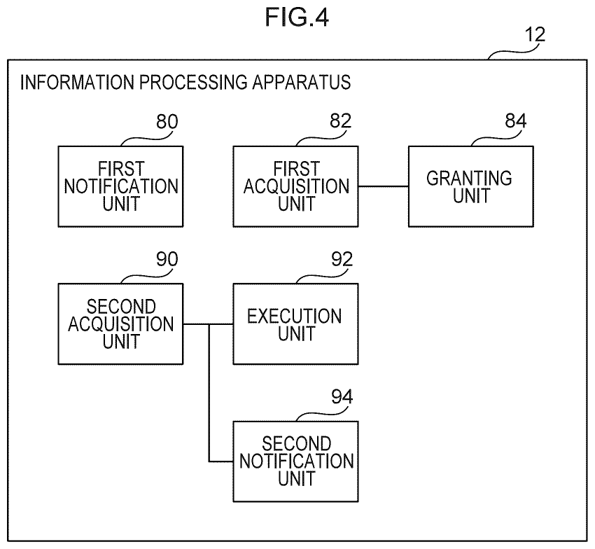

Next, a functional configuration of the information processing apparatus 12 will be described with reference to FIG. 4. As illustrated in FIG. 4, the information processing apparatus 12 includes a first notification unit 80, a first acquisition unit 82, a granting unit 84, a second acquisition unit 90, an execution unit 92, and a second notification unit 94. The CPU 21 executes the information processing program 40 to function as the first notification unit 80, the first acquisition unit 82, the granting unit 84, the second acquisition unit 90, the execution unit 92, and the second notification unit 94. The first notification unit 80, the first acquisition unit 82, and the granting unit 84 are functional units having functions executed by the first information processing apparatus 12. The second acquisition unit 90, the execution unit 92, and the second notification unit 94 are functional units having functions executed by the second information processing apparatus 12.

In a case in which the first character controlled by the first player loses to an enemy character, the first notification unit 80 notifies the information processing apparatus 14 of the loss of the first character to the enemy character. Specifically, in this case, the first notification unit 80 transmits identification information of the first player such as a player ID, identification information of the enemy character such as a character ID, the date of the loss, and a position of the loss to the information processing apparatus 14 via the communication I/F 26. The term “loss” as used herein means that the first character is attacked by the enemy character in a battle against the enemy character so that hit points become zero and the battle ends, for example. In addition, the loss may include the end of the battle by satisfying conditions other than winning the battle, such as the end of the battle by exceeding a time limit in one battle.

The CPU 51 of the information processing apparatus 14 stores the identification information of the first player, the identification information of the enemy character, the date of the loss, and the position of the loss, which have been transmitted from the first information processing apparatus 12, in association with each other in the storage 54 as the loss information 72. That is, in the loss information 72, information regarding the loss of the first character controlled by the first player to the enemy character in the first virtual space is accumulated. In the loss information 72, information regarding all the players may be accumulated, or information regarding some players such as 100 players from the top of the ranking may be accumulated.

The second acquisition unit 90 acquires the loss information 72 from the information processing apparatus 14 via the communication I/F 26. In the embodiment, the second acquisition unit 90 acquires the loss information 72 at each specific timing. Examples of the specific timing include every timing after a lapse of a certain period of time, and a timing at which the enemy character is rearranged, such as a timing at which the character controlled by the player reaches a check point provided in a stage. In addition, examples of the specific timing also include a timing at which the enemy character is initially arranged, such as at the start of the stage. Note that the second acquisition unit 90 may extract and acquire information regarding some players from the loss information 72 accumulated in the information processing apparatus 14, or may extract and acquire information regarding a part of a period such as the most recent week.

On the basis of the loss information 72 acquired by the second acquisition unit 90, the execution unit 92 enhances, in the second virtual space, an enemy character corresponding to the enemy character to which the first character has lost in the first virtual space. In the embodiment, the execution unit 92 enhances the enemy character by increasing the second level of the enemy character by a predetermined value. Since the second level according to the embodiment determines the variation amount of the numerical values indicating the ability of the character as described above, it is sufficient to store that the character is in an enhanced state. On the other hand, for example, if the second level determines the numerical values indicating the ability of the character, the enhanced numerical values are stored for each of the enemy characters. Therefore, since it is not necessary to store the enhanced numerical values for each of the enemy characters according to the embodiment, memory usage can be reduced as compared with the case of enhancing the character using the level that determines the numerical values indicating the ability of the character, and the implementation of the function can be facilitated.

Note that, in a case in which a plurality of the first characters controlled by a plurality of the first players have lost to one identical enemy character, the execution unit 92 may increase a degree of enhancement of the one enemy character as the number of first characters having lost to the one enemy character increases. The execution unit 92 can determine the number of first characters having lost to the one enemy character on the basis of the number of pieces of identification information of the first players associated with identification information of the one enemy character included in the loss information 72. In addition, in this case, the execution unit 92 may set an upper limit value of the degree of enhancement of the enemy character designated by the second player. In this case, the second player designates the upper limit value of the degree of enhancement of the enemy character via the input device 35.

In addition, the execution unit 92 may set a duration of a state in which the enemy character is enhanced so as to make the enhancement of the enemy character based on the loss information 72 temporary. In addition, the execution unit 92 may enhance the enemy character by increasing the first level of the enemy character, enhancing equipment of the enemy character, or the like.

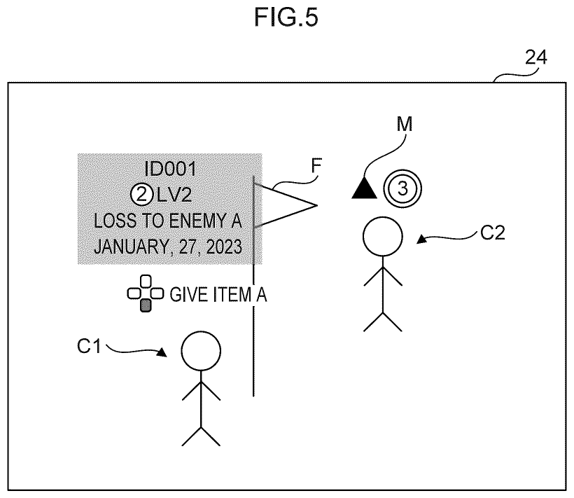

As illustrated in FIG. 5, the execution unit 92 displays a flag F, which is an example of a mark, at a position where the first character has lost to the enemy character on the basis of the loss information 72. Specifically, in the second virtual space, the execution unit 92 displays the flag F at a position corresponding to the position at which the first character has lost to the enemy character in the first virtual space. In FIG. 5, the second character in the second virtual space is denoted by C1, and the enemy character is denoted by C2. FIG. 5 illustrates a display example of a state in which the second character has approached the flag F to be within a predetermined distance and the second player has performed an operation of selecting the flag F.

In this case, as illustrated in FIG. 5, the execution unit 92 displays identification information of the first player who has lost to the enemy character at the position corresponding to the flag F, the second level and the first level of the first character at the time of the loss, and a name of the enemy character to which the first character has lost. In this case, the execution unit 92 further displays the date when the first character has lost to the enemy character. Further, in this case, the execution unit 92 displays a message prompting to give a specific item and an operation required to give the specific item. When the second player performs the operation for giving the specific item, the second character gives the specific item to the flag F. Examples of the specific item include a recovery item that recovers hit points of a character. In addition, the specific item in this case may be the same item as a predetermined number of items replenished at a check point in a stage. In the example of FIG. 5, an operation of pressing a down direction key is illustrated as the operation for giving the specific item. An action of the second character approaching the flag F to be within the predetermined distance and giving the specific item is an example of the predetermined action performed by the second character with respect to the flag F.

In addition, the execution unit 92 displays a numerical value indicating the second level of the enemy character and a mark M indicating that the enemy character has been enhanced on the basis of the loss information 72 above the enemy character.

In a case in which the second character performs the action of approaching the flag F to be within the predetermined distance and giving the specific item, the execution unit 92 enhances the second character. The execution unit 92 enhances the second character by increasing the second level of the second character by a predetermined value. Note that the second player may designate the number of specific items to be given to the flag F. In this case, the execution unit 92 may increase a degree of enhancement of the second character as the number of specific items given to the flag F by the second character increases. In addition, the execution unit 92 may enhance the second character by increasing the first level of the second character, enhancing equipment of the second character, or the like.

In addition, the execution unit 92 grants a benefit to the second player in a case in which the second character wins, in the second virtual space, against the enemy character corresponding to the enemy character to which the first character has lost in the first virtual space on the basis of the loss information 72. Examples of the benefit include a specific item such as a recovery item, an experience value that the second character can obtain, improvement in rarity of an item dropped by the enemy character in the second virtual space, and improvement in a drop rate of the item of the enemy character in the second virtual space. In addition, examples of the benefit also include opening of a new stage that can be played by the second player and improvement in the own level of the second player. The item granted as the benefit in this case may be the same item as the item given to the flag F described above.

Note that, in a case in which the second character wins against the enemy character to which the plurality of first characters controlled by the plurality of first players have lost, the execution unit 92 may grant a better benefit to the second player as the number of first characters having lost to the enemy character increases.

The second notification unit 94 notifies the information processing apparatus 14 of a win of the second character against the enemy character to which the first character has lost in a case in which the second character wins, in the second virtual space, against the enemy character corresponding to the enemy character to which the first character has lost in the first virtual space on the basis of the loss information 72. When receiving the notification from the second information processing apparatus 12, the CPU 51 of the information processing apparatus 14 notifies the first information processing apparatus 12, used by the first player controlling the first character that has lost to the enemy character defeated by the second character, of the notification. Note that, in a case in which the plurality of first players, who control the first characters that have lost to the enemy character defeated by the second character, exist, the CPU 51 may notify the first information processing apparatuses 12 used by all the first players. In this case, the CPU 51 may notify the first information processing apparatuses 12 used by some first players.

The first acquisition unit 82 acquires the notification that has been transmitted from the second information processing apparatus 12 via the information processing apparatus 14 and indicates the win of the second character against the enemy character corresponding to the enemy character to which the first character has lost.

The granting unit 84 grants a benefit to the first player in the first virtual space in a case in which it is notified that the second character has won against the enemy character to which the first character has lost. Examples of the benefit include a specific item such as a recovery item, an experience value that the first character can obtain, improvement in rarity of an item dropped by the enemy character in the first virtual space, and improvement in a drop rate of the item of the enemy character in the first virtual space. In addition, examples of the benefit also include opening of a new stage that can be played by the first player and improvement in the own level of the first player. The item granted as the benefit in this case may be the same item as the item given to the flag F described above.

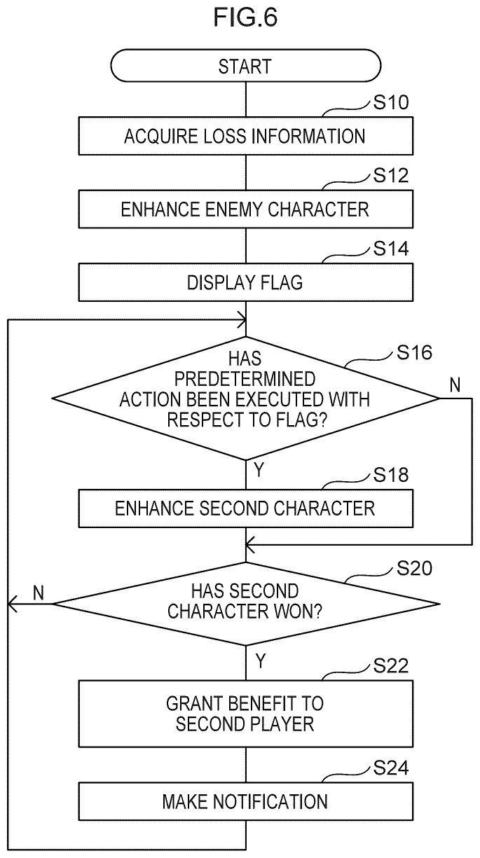

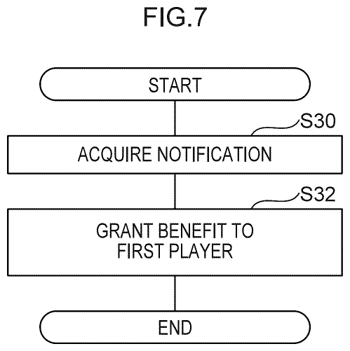

Next, an operational effect of the information processing apparatus 12 will be described with reference to FIGS. 6 and 7. When the CPU 21 of the second information processing apparatus 12 executes the information processing program 40, a notification process illustrated in FIG. 6 is executed. The notification process illustrated in FIG. 6 is executed at each specific timing described above. When the CPU 21 of the first information processing apparatus 12 executes the information processing program 40, a benefit granting process illustrated in FIG. 7 is executed.

In step S10 in FIG. 6, the second acquisition unit 90 acquires the loss information 72 from the information processing apparatus 14 via the communication I/F 26. In step S12, the execution unit 92 enhances, in the second virtual space, the enemy character corresponding to the enemy character to which the first character has lost in the first virtual space as described above on the basis of the loss information 72 acquired in step S10.

In step S14, the execution unit 92 displays the flag F at a position where the first character has lost to the enemy character on the basis of the loss information 72 as described above. In step S16, the execution unit 92 determines whether or not the second character has performed the above-described predetermined action with respect to the flag F. In a case in which a positive determination is made in the determination, the processing proceeds to step S18. In step S18, the execution unit 92 enhances the second character as described above. In a case in which a negative determination is made in the determination in step S16, the processing in step S18 is not executed, and the processing proceeds to step S20.

In step S20, the execution unit 92 determines whether or not the second character has won, in the second virtual space, against the enemy character corresponding to the enemy character to which the first character has lost in the first virtual space on the basis of the loss information 72. In a case in which a negative determination is made in the determination, the processing returns to step S16. In a case in which a positive determination is made, the processing proceeds to step S22.

In step S22, the execution unit 92 grants the benefit to the second player as described above. In step S24, the second notification unit 94 notifies the information processing apparatus 14 that the win of the second character against the enemy character to which the first character has lost. When the processing in step S24 ends, the processing returns to step S16.

When the first information processing apparatus 12 receives the notification transmitted from the second information processing apparatus 12 via the information processing apparatus 14 by the processing in step S24, the benefit granting process illustrated in FIG. 7 is executed.

In step S30 of FIG. 7, the first acquisition unit 82 acquires the notification that has been transmitted from the second information processing apparatus 12 via the information processing apparatus 14 and indicates the win of the second character against the enemy character corresponding to the enemy character to which the first character has lost. In step S32, the granting unit 84 grants the benefit to the first player in the first virtual space as described above. When the processing in step S32 ends, the benefit granting process ends.

As described above, it is possible to enable the first player to obtain the advantage of making the notification about the loss according to the embodiment.

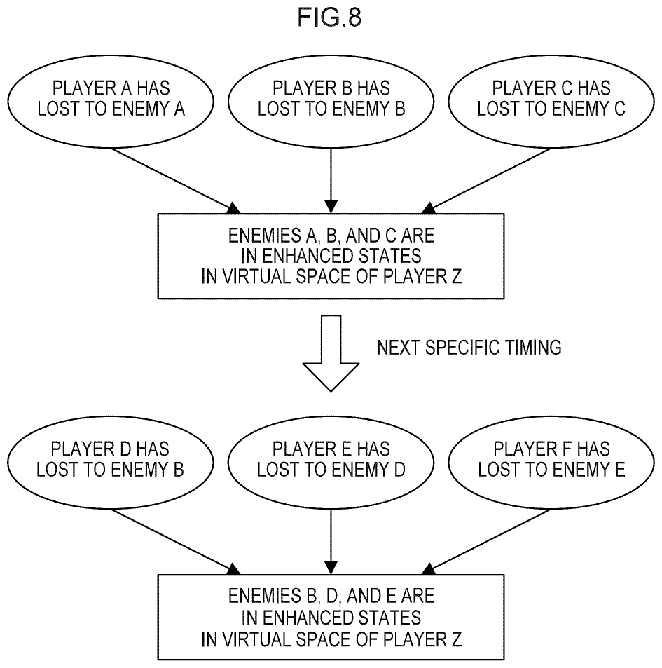

As illustrated in FIG. 8, according to the embodiment, the loss information 72 is acquired at each specific timing, and an enhanced state of an enemy character is updated on the basis of the loss information 72. Therefore, it is possible to suppress enhancement of only a specific enemy character.

Note that, in the above embodiment, the function implemented by the information processing apparatus 12, that is, the function of granting the benefit to the first player controlling the first character who has lost to the enemy character may be switchable between on and off. In this case, for example, the player switches the function between on and off by using a specific item.

In addition, various processes executed by the CPU 21 reading software (programs) in the above embodiment may be executed by various processors other than the CPU. Examples of the processors in this case include a programmable logic device (PLD) whose circuit configuration can be changed after manufacturing, such as a field-programmable gate array (FPGA), a dedicated electric circuit that is a processor having a circuit configuration exclusively designed for executing specific processing, such as an application specific integrated circuit (ASIC), and the like. In addition, the various processes may be executed by one of the various processors, or may be executed by any combination of two or more processors of the same type or different types (for example, a plurality of FPGAs, any combination of a CPU and an FPGA, and the like). More specifically, a hardware structure of the various processors is an electric circuit in which circuit elements such as semiconductor elements are combined.

What is claimed is:

1. A non-transitory computer-readable recording medium in which an information processing program is recorded, the information processing program causing a computer to execute:
acquiring loss information regarding a loss of a first character controlled by a first player to an enemy character; and
granting a benefit to the first player based on the loss information in a case in which a second character controlled by a second player, different from the first player, wins against the enemy character to which the first character has lost.

2. The non-transitory computer-readable recording medium in which the information processing program is recorded according to claim 1, wherein
the loss information is information regarding the loss of the first character to the enemy character in a first virtual space in which the first character is arranged,
the information processing program causing the computer to execute
granting a benefit to the first player in the first virtual space based on the loss information in a case in which the second character wins against an enemy character corresponding to the enemy character to which the first character has lost in the first virtual space in a second virtual space in which the second character is arranged, the second virtual space being different from the first virtual space.

3. The non-transitory computer-readable recording medium in which the information processing program is recorded according to claim 1, the information processing program causing the computer to execute
enhancing, based on the loss information, the enemy character to which the first character has lost.

4. The non-transitory computer-readable recording medium in which the information processing program is recorded according to claim 3, the information processing program causing the computer to execute
increasing, in a case in which a plurality of the first characters controlled by a plurality of the first players have lost to one identical enemy character, a degree of enhancement of the one enemy character as a number of the first characters having lost to the one enemy character increases.

5. The non-transitory computer-readable recording medium in which the information processing program is recorded according to claim 4, the information processing program causing the computer to execute
setting an upper limit value of the degree of enhancement designated by the second player.

6. The non-transitory computer-readable recording medium in which the information processing program is recorded according to claim 1, the information processing program causing the computer to execute
granting a benefit to the second player based on the loss information in a case in which the second character wins against the enemy character to which the first character has lost.

7. The non-transitory computer-readable recording medium in which the information processing program is recorded according to claim 6, the information processing program causing the computer to execute
granting a better benefit to the second player as a number of the first characters having lost to the enemy character increases in a case in which the second character wins against the enemy character to which a plurality of the first characters controlled by a plurality of the first players has lost.

8. The non-transitory computer-readable recording medium in which the information processing program is recorded according to claim 1, the information processing program causing the computer to execute:
displaying a mark at a position where the first character has lost to the enemy character based on the loss information; and
enhancing the second character in a case in which the second character performs a predetermined action with respect to the mark.

9. The non-transitory computer-readable recording medium in which the information processing program is recorded according to claim 1, the information processing program causing the computer to execute
acquiring the loss information at each specific timing.

10. An information processing method comprising:
acquiring, by a computer, loss information regarding a loss of a first character controlled by a first player to an enemy character; and
granting, by the computer, a benefit to the first player based on the loss information in a case in which a second character controlled by a second player, different from the first player, wins against the enemy character to which the first character has lost.

11. An information processing apparatus comprising
a processor, the processor being configured to:
acquire loss information regarding a loss of a first character controlled by a first player to an enemy character; and
grant a benefit to the first player based on the loss information in a case in which a second character controlled by a second player, different from the first player, wins against the enemy character to which the first character has lost.

12. An information processing system comprising: a first information processing apparatus including a processor and configured to provide a first virtual space in which a first character controlled by a first player is arranged; and a second information processing apparatus including a processor and configured to provide a second virtual space in which a second character controlled by a second player, different from the first player, is arranged, the second virtual space being different from the first virtual space,
wherein the processor of the second information processing apparatus is configured to
acquire loss information regarding a loss of the first character to an enemy character in the first virtual space, and
make a notification about a win of the second character against the enemy character to which the first character has lost based on the loss information in a case in which the second character wins, in the second virtual space, against an enemy character corresponding to the enemy character to which the first character has lost in the first virtual space, and
the processor of the first information processing apparatus is configured to
grant a benefit to the first player in the first virtual space in a case in which the notification about the win of the second character against the enemy character to which the first character has lost is made.
